(19) United States
(12) Patent Application Publication
(10) Pub. No.: US 2002/0011438 A1
(43) Pub. Date: Jan. 31, 2002

(54) Water purification treatment apparatus with large pore size filter membrane unit

(75) Inventors: Yoshitsugu Jimbo, Tokyo (JP); Takuya Onitsuka, Kanagawa (JP)

Correspondence Address: Jordan and Hamburg, 122 East 42nd Street, New York, NY, 10168, US

(73) Assignee: Suido Kiko Kaisha., Ltd.

(21) Appl. No.: 09/907,169

(22) Filed: Jul. 17, 2001

(30) Foreign Application Priority Data
Jul. 26, 2000 (JP) 2000/225510

(51) Int. Cl. B01D 63/00

(52) U.S. Cl. 210/321.6

(57) ABSTRACT

A water purification treatment apparatus with a large pore size filter membrane unit according to the present invention is arranged in which the filter membrane unit has a pore size ranging from 0.8 μm to 3.0 μm in the diameter and the filtered water is passed through the filter membrane unit by means of a difference in the water level between a pre-filtered raw water reservoir and the filter membrane unit for removal of pathogenic organisms.

### BACKGROUND OF THE INVENTION

1. Field of the Invention

The present invention relates to a water purification treatment apparatus with a large pore size filter membrane unit and particularly to its novel improvement in which pre-filtered water passed through raw water processing for coagulation-sedimentation, sand filtration, or granular activated carbon treatment is further filtered with a filter membrane unit by means of a difference in the water level between two different locations, thus removing pathogenic organisms from the pre-filtered water inexpensively and certainly.

2. Description of the Related Art

Conventional filter apparatuses for filtering raw water have been provided in which raw water is filtered by passing through raw water processing for coagulation-sedimentation, sand filtration, or granular activated carbon treatment and thus released as filtered effluent having at least one NTU (nephelometric turbidity unit) or less of the turbidity.

However, the conventional filter apparatuses fail to remove particular pathogenic organisms including Cryptosporidium of approximately five micrometers in size, Giardia of approximately seven micrometers in size, and Echinococcus of approximately tens micrometers in size. Those organisms may hardly be terminated with the use of a chlorine disinfection at the succeeding step.

For overcoming the above drawback, a water purification treatment apparatus is proposed such as disclosed in Japanese Patent Laid-open Publication (Heisei)11-300351.

More particularly, microfiltration membranes having pore size of 0.01 μm in the diameter smaller than the size of pathogenic organisms or of 0.1 to 0.2 μm in the diameter are used for filtering the raw water.

Such a conventional water purification treatment apparatus employing the above described filter membranes has the following drawback.

In common, as a difference in the water level between a sand filter or granular active carbon adsorption facility and a membrane-filtered water reservoir in a water treatment plant is as small as one meter, a feed pump has to be used for increasing the pressure to several hundreds of kPa to pass the water through the filter membranes. The filter membranes having a small pore size develop a large level of filter resistance, thus declining the membrane filtration flux to 1 to 2 m/d.

This small pore size filtration will cause the feed water pump to provide higher level of power consumption and increase running cost.

### SUMMARY OF THE INVENTION

The present invention is developed for eliminating the above drawback and its object is to provide a water purification treatment apparatus with a large pore size filter membrane unit arranged in which pre-filtered raw water processed by coagulation-sedimentation, sand filtration, or granular activated carbon treatment is conveyed and filtered through the filter membrane unit by means of a difference in the water level, thus removing pathogenic organisms from the pre-filtered water inexpensively and certainly.

A water purification treatment apparatus with a large pore size filter membrane unit according to the present invention which has a raw water processing for pre-filtering raw water by coagulation-sedimentation, sand filtration, or granular activated carbon treatment to have a filtered water, is provided comprising: a filter membrane unit provided beneath the pre-filtered raw water reservoir and having pores size of 0.8 to 3.0 μm, the filter membrane including a filtered water outlet located beneath the pre-filtered raw water reservoir, wherein the pre-filtered raw water can be transferred from the pre-filtered raw water reservoir to the filter membrane unit by means of a difference in the water level between the pre-filtered raw water reservoir and the filter membrane unit for removing pathogenic organism from the pre-filtered raw water. The filter membrane unit may be an external pressure type hollow fiber membrane unit and can be backwashed with air supplied from the filtered water outlet of the filter membrane unit. Alternatively, the filter membrane unit may be a submerged type flat membrane unit and its two actions, filtration and washing with air supplied from the inlet side thereof, can be carried out alternately.

### BRIEF DESCRIPTION OF THE DRAWINGS

FIG. 1 is a schematic view of a water purification treatment apparatus with a large pore size filter membrane according to the present invention;

FIG. 2 is a schematic view of a modification of the apparatus shown in FIG. 1;

FIG. 3 is a schematic view of another modification of the apparatus shown in FIG. 1;

FIG. 4 is a schematic view of a modification of the apparatus shown in FIG. 3; and

FIG. 5 is a characteristic diagram showing profiles of transmembrane pressure difference in the present invention apparatus and the conventional apparatus.

### DETAILED DESCRIPTION OF THE PREFERRED EMBODIMENTS

A preferred embodiment of the water purification treatment apparatus with a large pore size filter membrane unit according to the present invention will be described referring the relevant drawings.

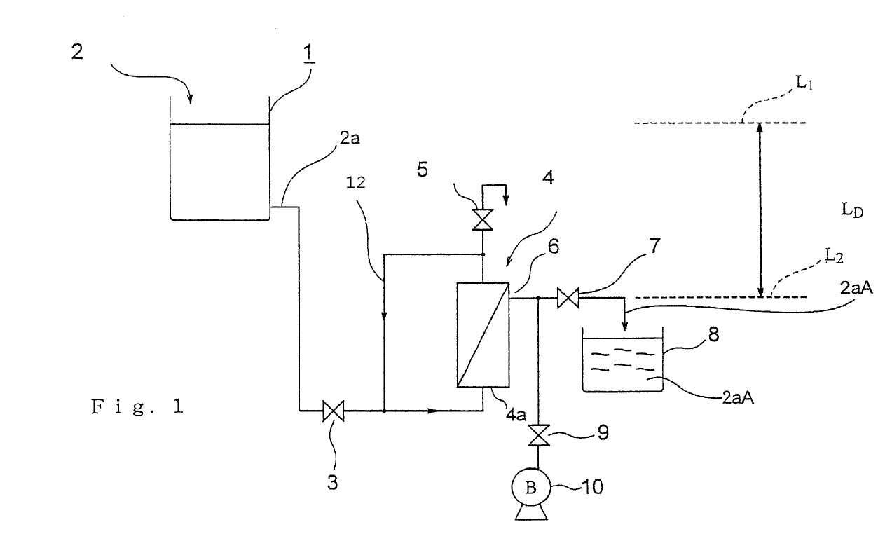

FIG. 1 is a schematic view of a first embodiment of the water purification treatment apparatus with a large pore size filter membrane unit according to the present invention.

In FIG. 1, denote by the numeral 1 is a reservoir that stores pre-filtered raw water 2a. Raw water received from rivers and lakes is pre-filtered by means of coagulation-sedimentation, and filtration, or granular activated carbon treatment. The pre-filtered raw water has one NTU or less of the turbidity and can be distributed as a drinking water by chlorine disinfection processed at next step. The pre-filtered raw water 2a is then transferred via a inlet valve 3 to the bottom 4a of a filter membrane unit 4 which is an external pressure type hollow fiber membrane arranged in the form of a known hollow fiber membrane module. An air purge valve 5 and a filtered water outlet 6 are provided at an upper side of the filter membrane unit 4.

A circulating water conduit 12 is connected at one end to between the air purge valve 5 and the top of the filter membrane unit 4 and at the other end to between the inlet valve 3 and the bottom 4a of the filter membrane unit 4.

The filtered water outlet 6 is communicated via a constant flow control valve 7 to a filtered water tank 8 where a finally filtered water 2aA from the filter membrane unit 4 is stored.

Also, connected between the filter membrane unit 4 and the constant flow control valve 7 is a valve 9 and a blower 10. Accordingly, when the blower 10 is driven with the valves 3 and 7 closed and the air purge valve 5 and the valve 9 opened, air can be taken from the filtered water outlet 6 into the filter membrane unit 4 for washing with a reverse flow.

As a difference LD is created between the water level L1 in the pre-filtered raw water reservoir 1 and the water level L2 at the filtered water outlet 6, the pre-filtered raw water 2a in the pre-filtered raw water reservoir 1 is filtered and passed from the lower end to the upper end of the filter membrane unit 4 by the action of the difference L_{D} in the water level. This allows the final filtered water 2aA from the filtered water outlet 6 to be received by the filtered water tank 8.

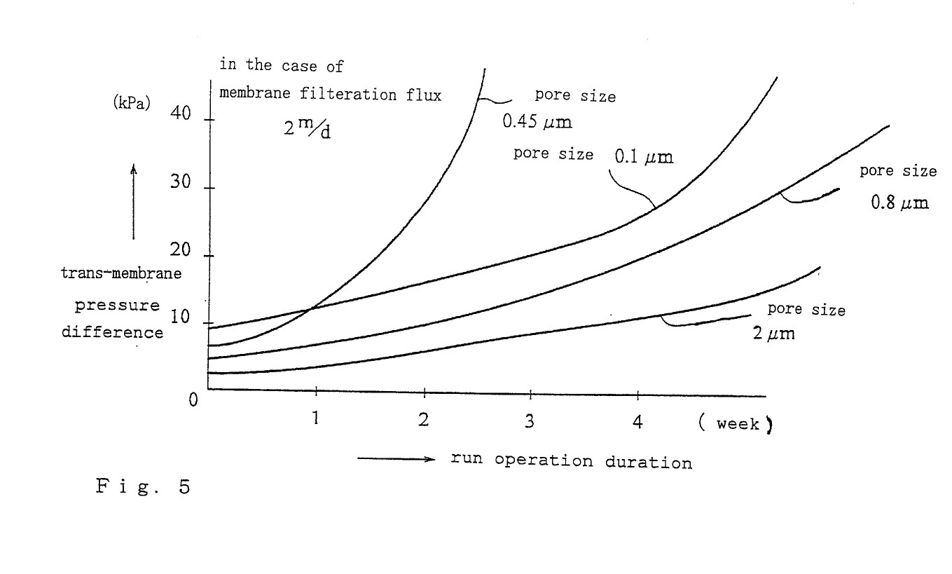

The diameter of each pore in the filter membrane unit 4 is defined by the present invention. More specifically, for filtering the pre-filtered raw water 2a processed to the drinking water quality level, at optimum relationship between the pore diameter and the transmembrane pressure difference required for filtration, the transmembrane pressure difference of a membrane with pore size ranging from 0.1 μm to 0.2 μm can stay lower after long-run operation in comparison with a membrane with pore size of smaller than 0.45 μm as shown FIG. 5. This may be explained by the fact that most suspended matter remaining in the pre-filtered raw water 2a are 0.1 to 0.45 μm in the diameter and when entering deep, block the pores, in the membrane.

If the pore size exceeds 0.45 μm, the profile of the transmembrane pressure difference shown in FIG. 5 will be changed. With the pore size ranging from 0.8 μm to 3 μm, the filtration can be stable for a long-run operation at a lower level of the transmembrane pressure difference than that with 0.1 to 0.2 μm.

The above range of the pore size finds difficult to remove suspended matter from pre-filtered raw water of a drinking water quality level but may be enough to eliminate pathogenic organisms (microorganisms) having a diameter of not smaller than 5 μm and particles having a diameter of greater than the pore size of 0.8 to 3 μm which are contained in the pre-filtered raw water 2a after the pre-filtration.

As the pore size ranging from 0.8 μm to 3 μm is relatively significant, it allows water such as the pre-filtered raw water which contains not much suspended matter to be passed through the membranes by as a small pressure as some tens to hundreds of kPa (low level than known bubbling point pressure). As a result, the membranes can readily be backwashed with air and their physical washing effect will be high, hence enabling more long-run operations.

The bubbling point pressure of conventional membranes having a pore size of 0.1 to 0.2 μm is 10 times higher than that of the present invention having a pore size of 0.8 to 3 μm. The backwashing with air (reverse flow washing) from the filtered water outlet 6 that is available in the present invention will hardly be feasible on the conventional membranes because of the higher air pressure. Therefore, the membranes with the pore size according to the present invention can be sustained through a long-run operation.

Unwanted chlorine-resistant pathogenic organisms including Cryptosporidium, Giardia, Echinococcus, and nematodes which are five to tens micrometers in the size and are commonly contained in the pre-filtered raw water 2a can successfully be removed nearly 100% with the use of filter membranes of 0.8 to 3 μm in the pore size according to the present invention.

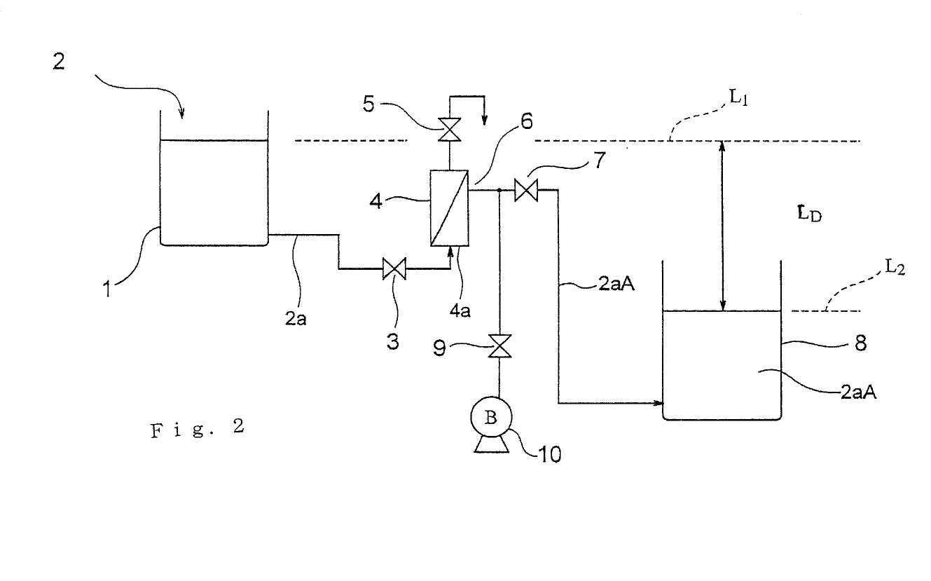

FIG. 2 illustrates a modification of the arrangement shown in FIG. 1 where the filtered water 2aA is transferred from the filter membrane unit 4 to a lower side of the filtered water tank 8 by the action of siphon effect. Like components are denoted by like numerals as those shown in FIG. 1 and will be explained in no more detail.

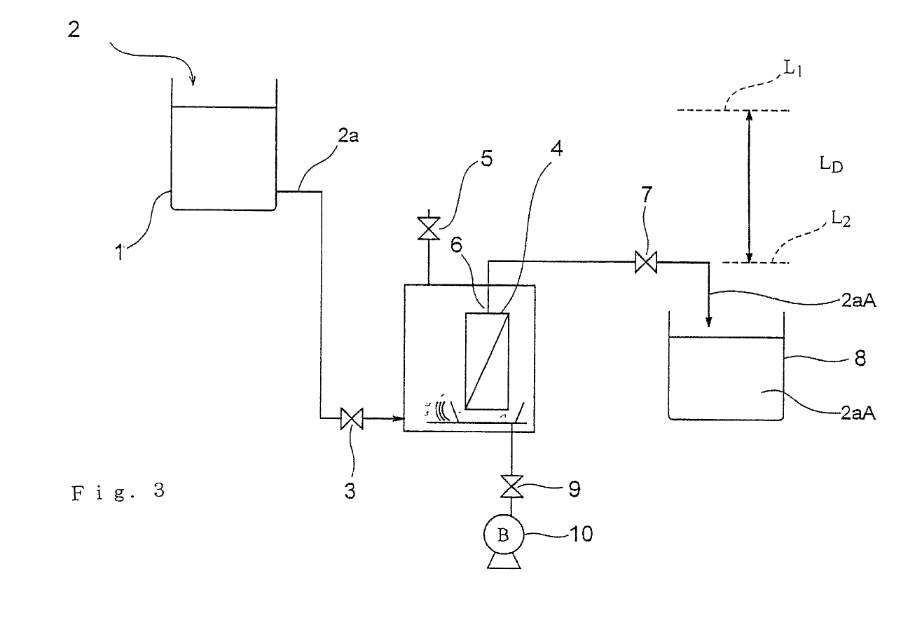

FIG. 3 illustrates another modification of the arrangement shown in FIG. 1 where the filter membrane unit 4 is not a hollow fiber membrane module but a known submerged type flat membrane unit. Also, like components are denoted by like numerals as those shown in FIG. 1 and will be explained in no more detail.

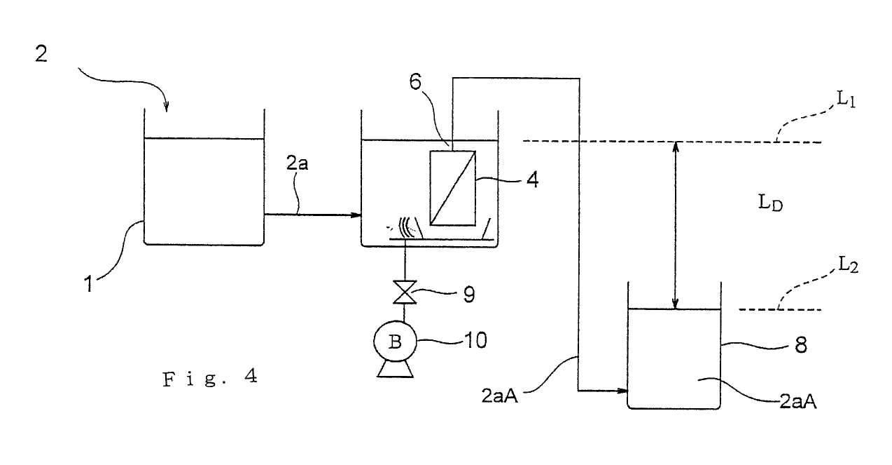

FIG. 4 illustrates a modification of the arrangement shown in FIG. 3 where the filtered water 2aA is transferred from the filter membrane unit 4 to a lower side of the filtered water tank 8 by the action of siphon effect. Also, like components are denoted by like numerals as those shown in FIG. 3 and will be explained in no more detail.

In both the arrangements shown in FIGS. 3 and 4, washing air can be introduced into the inlet side of the filter membrane unit 4.

It is desired that the filtration and the washing in each of the arrangements are carried out alternately.

Since the water purification treating apparatus with large pore size filter membranes according to the present invention provides the following advantages.

In action, primarily pre-filtered water processed by coagulation-sedimentation, sand filtration, or granular activated carbon treatment and having one NTU or less of the turbidity is transferred to the filter membrane unit incorporating a hollow fiber membrane module or a flat membrane unit having a pore size of 0.8 to 3 μm by means of the difference in the water level between the two tanks to remove pathogenic organisms. As a result, the filtration, which may result in clogging of a conventional membrane unit having a pore size of 0.1 to 0.2 μm or may be shortened in the operable life at a lower level of the flow pressure, can be carried out at stability throughout a longer duration of operation.

Also, as its pore size is greater than that of the prior art, the present invention can lower the bubbling point pressure. Accordingly, while its backwashing with air can be executed under a lower pressure, the apparatus can perform a filtering action at higher steadiness.

What is claimed is:

1. A water purification treatment apparatus with a large pore size filter membrane unit having raw water processing for pre-filtering raw water by coagulation-sedimentation, sand filtration, or granular activated carbon treatment to have a processed water, comprising:
filter membrane unit provided beneath a pre-filtered raw water reservoir and having pore size of 0.8 to 3.0 μm in the diameter, the filter membrane including a treated water outlet located beneath the pre-filtered raw water reservoir, wherein the filtered water can be transferred from the pre-filtered raw water reservoir to the filter membrane unit by mean of a difference in the water level between the pre-filtered raw water reservoir and the filter membrane unit for removing pathogenic organism from the pre-filtered water.

2. A water purification treatment apparatus with a large pore size filter membrane unit according to claim 1, wherein the filter membrane unit is an external pressure type hollow fiber membrane unit and can be backwashed with air supplied from the treated water outlet of the filter membrane unit.

3. A water purification treatment apparatus with a large pore size filter membrane unit according to claim 1, wherein the filter membrane unit is a submerged type flat membrane unit and its two actions, filtration and washing with air supplied from the inlet side thereof, can be carried out alternately.
